(19) United States
(12) Patent Application Publication
(10) Pub. No.: US 2007/0089796 A1
(43) Pub. Date: Apr. 26, 2007

(54) Medical air production systems

(76) Inventors: Tamara Electra Brown, Hamburg, NY (US); Bradley Hagstrom, Glen Ellyn, IL (US); Bernard Thomas Neu, Lancaster, NY (US); Friedrich Eduard Purkert, Buffalo, NY (US); M. Mushtaq Ahmed, Pittsford, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/259,450

(22) Filed: Oct. 26, 2005

(51) Int. Cl. B01F 5/04

(52) U.S. Cl. 137/896; 137/14

(57) ABSTRACT

The present invention relates to systems to supply medical grade air in which critical flow conditions for delivering oxygen and nitrogen to a system are provided. The ratio of pressure downstream of the orifices to the pressure upstream of orifices for the oxygen and nitrogen is maintained near or below critical pressure ratio.

### TECHNICAL FIELD

The present invention generally relates to compressor-free medical air systems that include mixing medical grade oxygen and medical grade nitrogen under critical flow conditions using orifices. Systems of the present invention can produce medical grade air products from oxygen and nitrogen sources and allow for product oxygen concentration to be substantially independent of conditions downstream of the critical flow orifices.

### BACKGROUND OF THE INVENTION

The United States Pharmacopeia (USP) considers “medical air” to be a natural or synthetic mixture of gases consisting largely of nitrogen and oxygen. USP standards require medical air to contain not less than 19.5% and not more than 23.5%, by volume of O₂. While requirements outside the United States may vary somewhat, “medical air” is generally defined in other countries similarly to that of USP standards. Medical air is a pharmaceutical product commonly used for two types of applications. First, medical air is used in breathing applications. Second, medical air is used for the calibration of respiratory medical equipment.

There are several systems currently used for producing medical air. Many of these systems use compressors to compress ambient air to produce medical air. For example, most medical air supplied to hospitals today is provided using on-site medical air compressors that compress ambient air. Requirements for such systems in the United States are provided by the National Fire Protection Agency (NFPA), which refer to standards of the USP. Given that these systems do not produce air from bulk oxygen and nitrogen sources, air can be provided to the hospital with a relatively stable oxygen concentration (i.e., at approximately the oxygen concentration of ambient outside air, about 20.9%). These systems, however, must contain systems of filters and dryers to treat outside air. Ambient air contains water and pollutants, including particulate and chemicals, such as carbon monoxide. In the 2002 edition of NFPA99C, Standard on Gas and Vacuum Systems, the NFPA identifies acceptable levels of moisture and pollutants, including a dewpoint level below 39° F., CO level less than 10 ppm, and less than 5 mg/m³ of permanent particulates sized 1 micron or larger in the air at normal atmospheric pressure. NFPA 99C also requires constant monitoring of dewpoint and carbon monoxide levels in medical air. (NPFA 99C, 2002 edition, sections 5.1.3.5.1, 5.1.3.5.15).

While systems that produce medical air by mixing oxygen and nitrogen are not currently offered commercially in the United States, other types of mixers for medical purposes exist and are offered in the United States. For example, air-oxygen mixers currently offered in the United States blend independent streams of gases (e.g., medical air and oxygen) for breathing purposes. One such system is the SK Med ME 202 Monitoring Mixer, manufactured by SK Med, Van Nuys, Calif. In this system, metering of the incoming gases is selectable by the user and controlled by an adjustable valve in order to provide a product with oxygen concentration ranging between 21% and 100%. Outgoing flow rate of the air-oxygen mixture is also selectable by the user and is controlled by a level flowmeter. Such a mixer is designed for point of use applications at the patient site.

Some healthcare facilities in countries other than the United States use medical air mixers to blend oxygen and nitrogen. One such system is the MAS-500, a synthetic medical air mixer offered commercially in Brazil from White Martins Gases Industriais, Ltda. In this system, oxygen and nitrogen flow through orifices that do not operate under critical flow conditions, and differential pressure switches are used to control the oxygen concentration. The pressure difference between the oxygen and nitrogen lines is allowed to vary within a predetermined value in order to ensure conforming oxygen concentration. Flow of oxygen and nitrogen is allowed to vary; changes in both upstream and downstream pressures affect the oxygen concentration.

In systems operating under non-critical flow conditions, the flow rate is directly proportional to the differential pressure across the orifice. Changes in either the upstream or downstream pressure can consequently cause changes in flow and consequently, oxygen concentration.

Due to the fixed oxygen concentration range requirements of the USP, controlling the relative proportions of oxygen and nitrogen are of primary interest when producing synthetic medical air.

### BRIEF SUMMARY OF THE INVENTION

The present invention relates to systems for the production of synthetic medical air by mixing known amounts of oxygen and nitrogen using orifices operating under critical flow conditions where an orifice is defined as any device providing metered flow, including, but not limited to, orifice plates, nozzles or the like. Certain upstream and downstream pressure conditions across the orifice create critical flow conditions for each component stream. The resulting synthetic medical air is sent to a surge tank before delivery to the hospital. The surge tank cycles within predetermined lower and upper pressure limits.

The ratio of the absolute pressure downstream of the oxygen orifice to the absolute pressure upstream of the oxygen orifice is near the critical pressure ratio, and preferably below the critical pressure ratio, for a substantial portion of the tank pressure cycle (i.e., the predetermined tank pressure range during normal operation and production of medical air). Additionally, the ratio of the absolute pressure downstream of the nitrogen orifice to the absolute pressure upstream of the nitrogen orifice is near the critical pressure ratio, and preferably below the critical pressure ratio, for a substantial portion of a tank pressure cycle.

More specifically, the present invention includes orifices positioned in the system such that critical flow conditions can be established to meter the flow of oxygen and nitrogen for mixing in order to produce a medical grade air product that satisfies the USP requirements for medical air. The orifices can be utilized within the medical air systems of the present invention to meter the flow of each of the two components, oxygen and nitrogen. Certain upstream and downstream pressure conditions across the orifice create critical flow conditions for each component stream. Pressure control regulators are installed within the medical air system upstream of each orifice in order to control pressure upstream of the orifice. If constant supply pressure exists, pressure control regulators may be eliminated from the system. The pressure downstream of the orifice is also maintained by the system by limiting the tank pressure to a predetermined pressure range.

These controls within the design allow for the condition of critical flow during routine operation of the system. Controls within the design thus provide that the oxygen concentration is substantially independent from changes in the conditions downstream of the system due to pressure and/or flow variation(s). While not to be construed as limiting, these controls within the design provide that the medical air system produces medical air that can satisfy specified criteria (e.g. USP or other relevant standards).

In one embodiment of the invention described hereafter, it is noted that the pressure ratio (i.e., the ratio of pressure downstream of the orifice to the pressure upstream of the orifice) is at or below the theoretical critical pressure ratio of air, 0.5285, for all combinations of parameters during normal operation (i.e., pressures upstream and downstream of the orifices) with the exception of non routine operating conditions at points at or near the upper limit of the tank pressure cycle (e.g., in the range of 80-82 psig) when the pressure upstream of either or both orifice(s) is low (e.g., at 165 psig). In such instances, the pressure ratio slightly exceeds the theoretical value of the critical pressure ratio, to about 0.54. (The theoretical value of the critical pressure ratio for nitrogen and oxygen is about the same as that of air, 0.5285.) In these instances, the pressure ratio rises slightly above 0.5285 and, as medical air is drawn by the hospital, tank pressure decreases, and the pressure ratio returns to values at and below 0.5285 during the cycle.

During the design of the exemplary medical air system, oxygen and nitrogen orifices and the surge tank are sized and process control limits (i.e., oxygen and nitrogen pressures at the inlet of the respective orifice(s), tank pressure lower and upper limits) are established. As designed, during non-routine operating conditions, a substantial portion of the tank pressure cycle (in this embodiment, for example, at least 85% of the tank pressure range) is operating under critical flow conditions. As such, the production of synthetic medical air product continues such that product oxygen concentration remains substantially independent of the conditions downstream of the orifices. It will be appreciated by those skilled in the art that if the system is operating at pressure ratios at or below the theoretical critical pressure ratio of 0.5285 for too small a fraction of the tank cycle pressure range, one would expect that medical air oxygen concentration would become dependent on conditions downstream of the medical air system, for example pressure and/or flow changes (e.g., usage) in addition to dependence on conditions upstream of the orifice.

The present invention thus provides systems and processes that allow for the production of synthetic medical air product from oxygen and nitrogen sources such that product oxygen concentration is substantially independent of the conditions downstream of the medical air system. As discussed herein, systems of the present invention accordingly ensure critical, or sonic, flow through each orifice and eliminate variation in flow due to changes in downstream conditions. Regulating the pressure(s) upstream of the orifices and establishing critical flow conditions across the orifices provide for consistent ranges of flows of the oxygen and nitrogen component gases. Consistent flow ranges of each component gas ensure that manual adjustments are not needed to provide product concentrations meeting the USP requirements for medical air.

The present invention accordingly provides systems in which changes in customer demand based on the medical air usage within the facility or hospital do not substantially affect the oxygen concentration. The ability to better control the oxygen concentration within USP-specified limits is advantageous. Moreover, the increased ability of the systems of the present invention to handle fluctuations in customer demand provides less likelihood of equipment shutdowns and customer dissatisfaction.

### BRIEF DESCRIPTION OF THE DRAWINGS

For a more complete understanding of the present invention and the advantages thereof, reference should be made to the following Detailed Description taken in conjunction with the accompanying drawings in which:

FIG. 1 illustrates a synthetic medical air supply system in accordance with the present invention;

FIG. 2 shows a cross sectional view of an exemplar for a mixing component suitable for use in accordance with the present invention;

FIGS. 3(a)-3(f) illustrate various embodiments for a mixing component suitable for use in accordance with the present invention; and

FIG. 4 shows the oxygen concentration and outgoing flow (customer demand) as a function of time in accordance with one example of the present invention.

### DETAILED DESCRIPTION

As discussed hereinabove, the present invention relates to systems for the production of synthetic medical air by mixing known amounts of oxygen and nitrogen using orifices operating under critical flow conditions. The ratio of pressure downstream of either the oxygen or nitrogen orifice(s) to the pressure upstream of either the oxygen or nitrogen orifice(s) respectively is near the critical pressure ratio, and preferably below the critical pressure ratio.

More specifically, the present invention includes orifices positioned in the system such that critical flow or near-critical flow conditions can be established to meter the flow of oxygen and nitrogen for mixing in order to produce a medical grade air product that satisfies the USP requirements or other requirements having specified oxygen concentrations. The orifices can be utilized within the medical air mixing systems of the present invention to meter the flow of each of the two components, oxygen and nitrogen. Control of upstream and downstream pressure conditions create critical flow conditions for each component stream for a substantial portion of a tank pressure cycle.

Critical flow (also called choked or sonic flow) through an orifice is not dependent upon downstream pressure and, therefore, allows consistent flow of oxygen and nitrogen. Critical flow is discussed in Perry's Chemical Engineers' Handbook (seventh edition, 6-21 through 6-26, 1997). Under critical flow conditions, the critical pressure ratio, p^{□}/p₀, is given by:

$$\frac{{p}^{•}}{{p}_{0}} = {[ 2 / ( k + 1 ) ]}^{\{ k / ( k - 1 ) \}} ,$$

where p^{□} is the critical pressure (also equivalent to the absolute pressure at the exit of the orifice), p₀ is the absolute pressure at the inlet of the orifice and k is the ratio of specific heats. For example, the value of k for air is 1.4; therefore, the critical pressure ratio for air using the equation above is theoretically 0.5285.

Thus, at critical flow conditions for air, the relationship between the pressure downstream (i.e., at the exit) of the orifice and the pressure upstream (i.e., at the inlet) of the orifice is:
p^{□}=0.5285p₀.

Under non-critical flow conditions, the mass velocity, G, is a function of downstream and upstream conditions. When the flow is choked, the mass velocity at sonic flow conditions G^{□} is independent of external downstream pressure as shown in the equation below
G^{□}=p₀{[kM_{w}/RT₀]*[2/(k+1)]^{(k+1)/(k-1)}}^{1/2},
where M_{w} is the molecular weight, R is the ideal gas universal constant, and T₀ is the absolute temperature of the gas entering the orifice. Reducing the downstream pressure below the critical pressure p^{□} will therefore not increase the flow. The mass flow rate under choking conditions is directly proportional to the upstream pressure. (Perry's Chemical Engineers' Handbook, seventh edition, 6-23, 1997)

The critical pressure ratio for air thus theoretically occurs when the ratio of the pressure at the orifice exit to the pressure entering the orifice is approximately one-half. To provide a practical mixing system, a range of upstream pressures and downstream pressures must be allowed. Such a practical system may contain a surge tank. Because hospital consumption of medical air does not necessarily equal the rate of medical air production, the tank pressure increases and decreases according to hospital demand. Given that the tank pressure cycles between predetermined limits, testing has been used to demonstrate substantial independence of oxygen concentration upon downstream conditions (sufficient to maintain USP or other oxygen concentration standards).

NFPA 99C provides requirements that the pressure of Medical Air at the patient outlet conforms to the pressure range of 50-55 psig. (NFPA99C, 2002 edition, Table 5.1.11). Additionally, the American Society of Plumbing Engineers (ASPE) specifies a maximum pressure drop of 5 psig for central supply piping for Medical Air (ASPE Data Book 3 Plumbing Engineer's Guide to System Design and Specifications: Special Plumbing Systems).

With consideration of these specifications, the pressure of medical air exiting the system into the central supply piping of the hospital must be 55-60 psig, ideally 60 psig, as controlled, for example, by pressure control regulator.

Additionally, to deliver the required flow to the pressure regulator, the system tank must be maintained at a higher pressure. For example, the system tank may operate at a minimum of 10 psig higher than the pressure supplied to the central piping of the hospital.

The upper limit for the tank cycle may be determined by considering various factors, for example, maximizing the range of the tank pressure cycle while observing the bulk supply pressure constraints.

By defining the critical pressure (i.e., pressure at the exit of the orifice) as the upper limit for the tank cycle and by using the theoretical critical pressure ratio of 0.5285, the target pressure upstream of the orifice can thus be calculated.

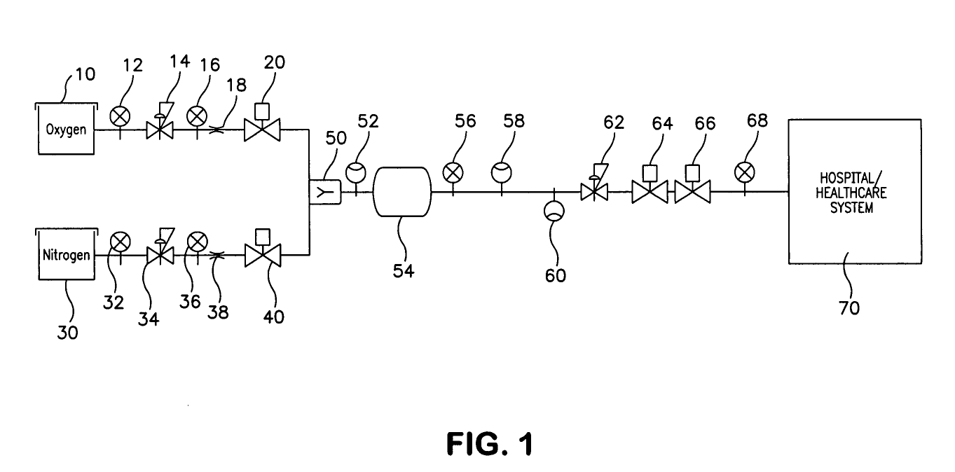

Because the pressure across the orifice(s) is important for establishing critical flow, in practice the orifices are positioned within the system between component sub-systems that allow for the detection and control of the pressures both upstream and downstream of the orifice(s). In addition to the components described below and those illustrated shown in FIG. 1, additional components are preferably installed for safety purposes and for connection to ancillary systems. Additional systems can also be included for automating various parts of the system.

Referring now to FIG. 1, a system for the production of synthetic medical air in accordance with the present invention is shown.

Upstream Pressure Detection and Control

Bulk supplies of oxygen 10 and nitrogen 30 are vaporized, and the two gases are fed into the system in separate streams. Oxygen 10 is preferably medical grade oxygen and more preferably, oxygen 10 is oxygen USP (e.g., oxygen containing not less than 99.0 percent, by volume O₂). Nitrogen 30 is preferably medical grade nitrogen, and more preferably nitrogen 30 is nitrogen NF (National Formulary) (e.g., nitrogen containing not less than 99.0 percent, by volume N₂). In this system, installation provisions are designed to allow supply of the oxygen and nitrogen from their respective sources, for example at pressures in the range between 180 psig and 200 psig.

A combination of pressure regulators and pressure monitors are installed to detect discrepant pressure conditions and to ensure upstream pressure control on each line of the oxygen and nitrogen. For example and as illustrated in FIG. 1, the pressures of the oxygen and nitrogen entering the system are monitored respectively by gauge pressure transmitters 12, 32.

If the pressure on either of the oxygen or nitrogen lines at transmitter 12 or transmitter 32 fall below a predetermined value (for example, below 180 psig), an under-pressure alarm will activate, and further processing is prohibited. Likewise, if the pressure on either of the oxygen or nitrogen lines at transmitter 12 or transmitter 32 rises above a predetermined value (for example, above 200 psig), an over-pressure alarm will activate, and further processing is prohibited.

Respective pressure regulating systems (i.e. pressure regulators) 14, 34 for oxygen and nitrogen are installed and designed to regulate the pressure of the oxygen and nitrogen to the respective orifices 18, 38 within a pressure range, for example, 165-175 psig. Preferably, regulators 14, 34 regulate the pressure of oxygen and nitrogen entering the respective orifices to a specific pressure, for example at 171.5 psig, as set manually or by automatic process controls. These orifices are independently sized and made of materials suitable for oxygen or nitrogen service, for example stainless steel or brass. The orifices deliver gases in the proper ratio in order to provide the proper concentration of oxygen in the mixture. Although excessive particulate is not expected in medical gases, strainers can be included on each line to prevent any matter from clogging the orifices.

If the pressure on either of the oxygen or nitrogen lines at transmitter 16 or transmitter 36 falls below a predetermined value (for example, below 165 psig), an under-pressure alarm will activate, and further processing is prohibited. Likewise, if the pressure on either of the oxygen or nitrogen lines at transmitter 16 or transmitter 36 rises above a predetermined value (for example, above 175 psig), an over-pressure alarm will activate, and further processing is prohibited. This provides a mechanism for detecting malfunctioning regulators.

Mixing Process

Both the oxygen and nitrogen lines contain orifices sized for a predetermined maximum medical air flow rate to the hospital. After the gases are metered by the orifices, oxygen solenoid valve 20 and nitrogen solenoid valve 40 allow the gases into mixing component 50. It will be appreciated by those skilled in the art that the solenoid valves could alternatively be positioned upstream of the orifices.

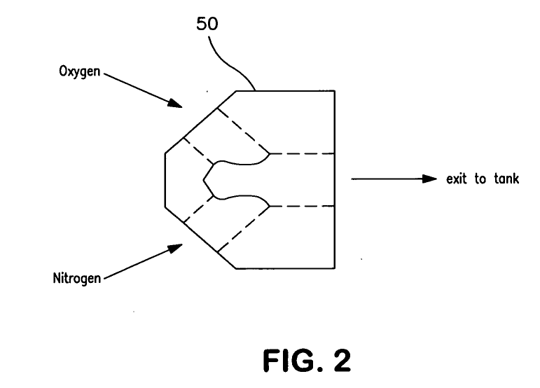

Oxygen and nitrogen from respective orifices flow into mixing component 50 to produce medical air to be delivered to the tank. Oxygen and nitrogen are thus mixed within the mixing component or within the piping following the mixing component to produce a synthetic medical air product having an oxygen concentration within a specified range. Mixing component 50 may allow flow of each gas from an independent supply line to converge to a single line leading to the tank, as shown for example in FIG. 1. A cross sectional view of an exemplar for such a mixing component is shown in FIG. 2.

Mixing component 50 can be made of any material suitable for oxygen and nitrogen service, for example brass or stainless steel. The mixing component can be constructed in a variety of ways. For example, it may be formed as a tee followed by additional piping to the tank. While not to be construed as limiting, mixing component 50 may also be designed with geometries to allow side injection, tangential, opposed flow, concentric, or other forms of mixing.

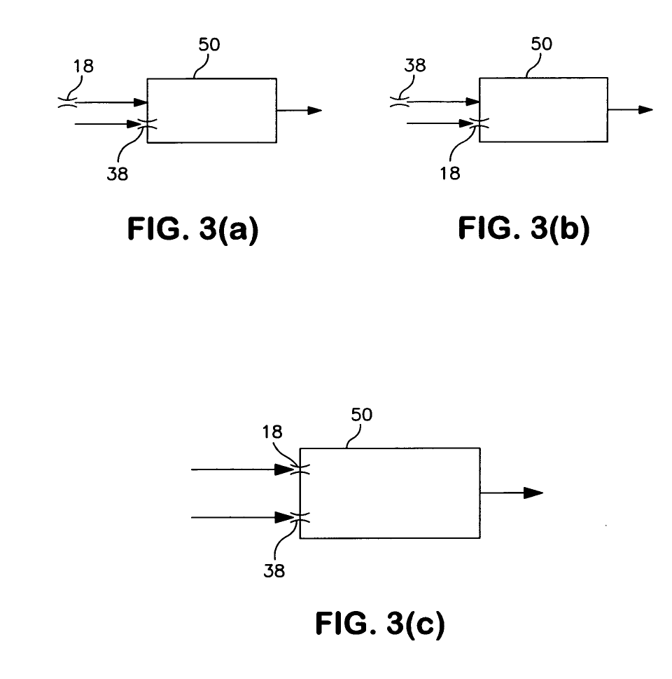

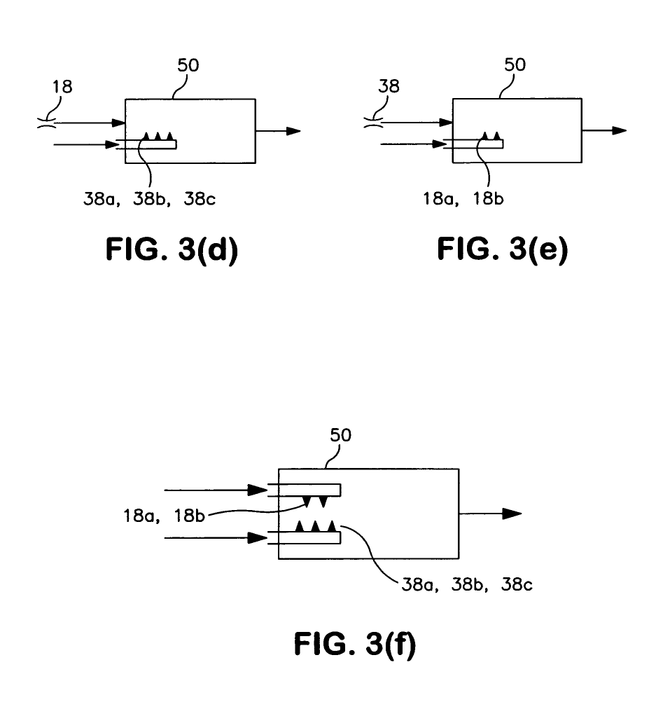

Alternately or in addition, either oxygen orifice 18 or nitrogen orifice 38 may be integrated into mixing component 50 as illustrated in FIGS. 3(a) and 3(b), or both orifices may be integrated into mixing component 50 as illustrated in FIG. 3(c). In yet other alternative embodiments as shown for example in FIGS. 3(d), 3(e), and 3(f), oxygen and/or nitrogen can be injected using multiple orifices (18a, 18b, 18c . . . 18n for oxygen and 38a, 38b, 38c . . . 38n for nitrogen) (size and number chosen appropriately to deliver known amounts of oxygen and nitrogen) to form synthetic medical air. These approaches may yield a more compact design.

Downstream Pressure Detection and Control

Gauge pressure transmitter 56 is installed in the line downstream of the tank to monitor surge tank 54 pressure. Tank 54 pressure governs the actuation of the oxygen and nitrogen solenoid valves 20, 40, for example through a computerized pressure switch. The two valves 20, 40 open at a specific tank pressure, for example at 70 psig, and close at a specific higher tank pressure, for example 82 psig, as monitored by the gauge pressure transmitter 56. This pressure range provides the limits for the tank pressure cycle.

For safety precautions, a shut-down mechanism (e.g. a computer generated alarm) can be implemented to avoid over-pressurization of the system. This is activated when the tank pressure exceeds a specific limit, for example, 90 psig. Although at tank pressures between 82 psig and 90 psig, the pressure ratios are maintained below 0.5285 over a majority of the tank pressure, these ranges are not considered within the normal operating limits of the system.

Oxygen Concentration Analysis

Analysis of the oxygen concentration may be performed at distinct locations. In one embodiment for example and as shown in FIG. 1, oxygen concentration is measured before the medical air product enters surge tank 54 via oxygen analyzer 52. Oxygen concentration can also be measured after surge tank 54 using a second oxygen analyzer 58. Analysis of carbon monoxide and dew point levels may also be performed by including one or more (e.g. two) optional analyzers 60.

Product Delivery to Hospital

Pressure regulator 62 is installed to reduce pressure prior to delivering medical air to the medical air central supply system 70 of the hospital or facility. Two solenoid valves 64, 66 may also be installed for product isolation (i.e. in order to keep the product isolated from entry into the system). It will be appreciated that only one solenoid valve for product isolation may be necessary in accordance with the present invention. For example and while not to be construed as limiting, medical air can be delivered to the central supply system at a typical pressure of 60 psig. A pressure indicator/transmitter 68 is installed to measure the pressure delivery pressure.

It will be appreciated that the flow rate of medical air delivered to the medical air central supply system of a facility or hospital may range at various times from zero to the maximum flow capacity of the system(e.g., approximately 4000 scfh). Because the orifices are sized to allow flow through each orifice to produce enough medical air for the maximum flow capacity of the system, the rate of consumption does not change the amount of medical air production. As the consumption (outgoing flow rate) changes, the frequency of tank pressure cycling changes. However, the change in cycling frequency does not substantially affect the flow through each orifice given consistent upstream pressures.

In the exemplary system operating at the parameters described hereinabove, pressure to the orifices is regulated to be within the range of 165-175 psig and nominally at 171.5 psig, and the pressure downstream of the orifices corresponding to the tank cycle is regulated to be within the range of 70-82 psig. Given that the pressure ratio is the absolute pressure downstream of the orifice to the absolute pressure upstream of the orifice, the system operates with orifices at pressure ratios ranging between 0.45-0.52 under nominal operating conditions (i.e. at 171.5 psig upstream of the orifices). Under non-nominal conditions (i.e., where the regulated pressure (the pressure upstream of the oxygen and/or nitrogen orifice) is close to the lower limit, for example, 165 psig and the tank pressure is operating at its upper pressure limit, for example, 82 psig), then the pressure ratio will be about 0.54, a value greater than the theoretical critical pressure ratio. The pressure ratio will return to a value below the theoretical pressure ratio as the tank pressure decreases.

Thus, under such non-nominal conditions, the system operates with orifices at pressure ratios no less than 0.45 and no greater than 0.54.

Those skilled in the art will appreciate that in these calculations, the absolute pressure is 14.7 psi greater than the gauge pressure. Those skilled in the art will further appreciate that absolute pressure can change or vary geographically and calculations of the absolute pressure can be adjusted accordingly.

### EXAMPLE

Features of the system described above were tested in accordance with the settings shown in Tables 1 and 2.

TABLE 1
Test System Set-up Parameters

| Parameter | Setting | |
|---|---|---|
| Pressure Incoming Nitrogen | 200 | psig |
| Pressure Incoming Oxygen | 200 | psig |
| Regulated Pressure, Nitrogen | 171.5 | psig |
| Regulated Pressure, Oxygen | 171.5 | psig |
| Outgoing Pressure | 60 | psig |

As a part of the testing, the outlet flow rate was varied according to the targets provided in Table 2. No other adjustments were made over the course of the testing. The time of the flow rate change was recorded as well as the actual flow setting. After allowing the system to operate for a minimum of 15 minutes, outlet pressure was recorded as well as the readings from the two medical air system oxygen analyzers. Additionally, for the test setup, a third oxygen analyzer was used to verify oxygen concentration independently of the system analyzers. Cycle times were also recorded on a reference only basis. Subtests were completed in the sequence provided in Table 2 and without interruption or adjustments between subtests.

TABLE 2
Outgoing Flow Rate Settings

| Sub-Test | Target Flow Rate(scfh) |
|---|---|
| 1 | 4000 |
| 2 | 3000 |
| 3 | 2000 |
| 4 | 1000 |
| 5 | 250 |
| 6 | 0 |
| 7 | 250 |
| 8 | 1000 |
| 9 | 2000 |
| 10 | 3000 |
| 11 | 4000 |
| 12 | 1000 |
| 13 | 3000 |
| 14 | 0 |
| 15 | 2000 |
| 16 | 0 |
| 17 | 4000 |

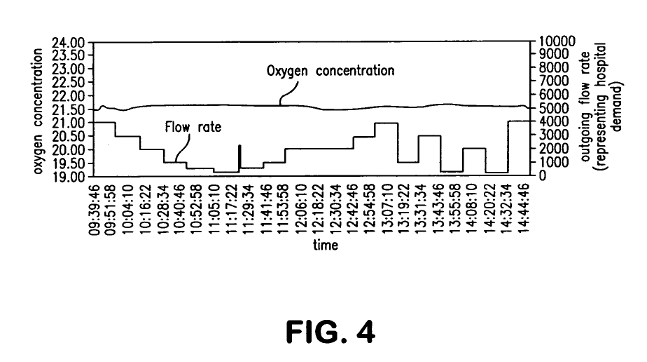

FIG. 4 shows the oxygen concentration trend corresponding to manual adjustments to outgoing flow rate (simulating hospital demand) over the approximate five-hour test period. Points of sudden flow changes can be seen as monetary spikes in the data set. For example and as shown in FIG. 4, at 11:05, the system outlet valve was closed, simulating zero demand or no flow to the facility/hospital outlet. Just prior to this change, oxygen concentration was in the 21.6% range. The independent analyzer reported that oxygen concentration remained in the 21.6% range for 15 seconds. Thereafter, a spike in oxygen concentration from 21.76% to 22.13% was observed; this spike lasted a total of 15 seconds before descending back toward original oxygen concentration ranges. In less than one minute from the time of the change (i.e., before 11:06), the analyzer reported oxygen concentration values in the original range of 21.6%. At no time did these spikes exceed the USP oxygen concentration limits. As shown in this graph, oxygen concentration was within USP limits for all flow rates.

Further analysis showed that the average oxygen concentration at any given target flow rate is not statistically different from that at any other target flow rate. Average oxygen concentrations at each flow rate are provided in Table 3.

TABLE 3
Oxygen Concentration by Flow Rate

| Outgoing Flow | Average Oxygen |
|---|---|
| Rate (scfh) | Concentration (%) |
| 0 | 21.58 |
| 250 | 21.57 |
| 1000 | 21.56 |
| 2000 | 21.53 |
| 3000 | 21.57 |
| 4000 | 21.47 |

The present invention results in systems for the production of synthetic medical air that reduce the likelihood of shutdowns (i.e., as in from non conforming oxygen concentrations), thereby decreasing costs related to maintenance needed to resume system operation, and reduce the likelihood of exceeding medical air oxygen concentration limits. The elimination of the need for manual adjustments provides the customer with ease of use.

One of ordinary skill in the art will further appreciate that the above description is exemplary of the synthetic medical air systems of the present invention. In an alternative embodiment for example, a system could be designed in which only one of oxygen or nitrogen are supplied using a critical flow orifice.

It should be appreciated by those skilled in the art that the specific embodiments disclosed above may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A system for the production of synthetic air, comprising:
a source of oxygen;
a first pressure regulator connected to the oxygen source;
a first pressure gauge configured to indicate the pressure from the first pressure regulator;
a first orifice having a predetermined size and configured to receive oxygen at a pressure of about the pressure indicated from the first pressure gauge;
a source of nitrogen;
a second pressure regulator connected to the nitrogen source;
a second pressure gauge configured to indicate the pressure from the second pressure regulator;
a second orifice having a predetermined size and configured to receive nitrogen at a pressure of about the pressure indicated from the second pressure gauge;
a mixing component configured to receive the oxygen and nitrogen;
a tank configured to operate within a tank pressure cycle having a predetermined tank pressure range and to receive the oxygen and the nitrogen to provide synthetic air having a predetermined concentration of oxygen,
wherein the system is configured to operate with a ratio of the tank absolute pressure to the absolute pressure entering the first orifice less than about 0.54 and at or below 0.5285 for a substantial portion of the tank pressure range, and
wherein the system is configured to operate with a ratio of the tank absolute pressure to the absolute pressure entering the second orifice less than about 0.54 and at or below 0.5285 for a substantial portion of the tank pressure range.

2. The system of claim 1, wherein the system is configured to operate with the ratio of the tank absolute pressure to the absolute pressure entering the first orifice between about 0.45 and 0.54 and wherein the system is configured to operate with the ratio of the tank absolute pressure to the absolute pressure entering the second orifice between about 0.45 and 0.54.

3. The system of claim 1, wherein the predetermined tank pressure range has an upper pressure limit and a lower pressure limit, wherein the difference between the upper pressure limit and the lower pressure limit is 1-20 psi.

4. The system of claim 3, wherein the difference between the upper pressure limit and the lower pressure limit is 5-15 psi.

5. The system of claim 4, wherein the difference between the upper pressure limit and the lower pressure limit is 12 psi.

6. The system of claim 5, wherein the predetermined tank pressure range is between about 70-82 psig.

7. The system of claim 6, wherein the oxygen pressure from the first pressure regulator is operable at between about 165-175 psig.

8. The system of claim 7, wherein the oxygen pressure from the first pressure regulator is operable at about 171.5 psig.

9. The system of claim 6, wherein the nitrogen pressure from the second pressure regulator is operable at between about 165-175 psig.

10. The system of claim 9, wherein the nitrogen pressure from the second pressure regulator is operable at about 171.5 psig.

11. The system of claim 6, wherein the oxygen and nitrogen pressures from the first and second pressure regulators respectively are operable at about 165-175 psig.

12. The system of claim 11, wherein the oxygen and nitrogen pressures from the first and second pressure regulators respectively are operable at about 171.5 psig.

13. The system of claim 1, wherein the oxygen and nitrogen pressures from the first and second pressure regulators respectively are operable at about 165-175 psig.

14. The system of claim 1, wherein the synthetic air contains not less than 19.5% and not more than 23.5% by volume of O₂.

15. The system of claim 1, wherein the mixing component is configured to allow flow of the oxygen and the nitrogen from independent supply lines to converge to a single line leading to the tank.

16. The system of claim 1, wherein the first and the second orifices are incorporated into the mixing component.

17. The system of claim 1, wherein the mixing component is configured for side injection.

18. The system of claim 1, wherein the mixing component is configured for tangential mixing.

19. The system of claim 1, wherein the mixing component is configured for opposed flow mixing.

20. The system of claim 1, wherein the mixing component is configured for concentric mixing.

21. A system for the production of synthetic air, comprising:
a source of oxygen;
first pressure regulator means connected to the oxygen source;
a first orifice having a predetermined size and configured to receive oxygen at a pressure of about the pressure from the first pressure regulator means;
a source of nitrogen;
second pressure regulator means connected to the nitrogen source;
a second orifice having a predetermined size and configured to receive nitrogen at a pressure of about the pressure from the second pressure regulator means;
a mixing component configured to receive the oxygen and nitrogen;
a tank configured to operate within a tank pressure cycle having a predetermined tank pressure range and to receive the oxygen and the nitrogen to provide synthetic air having a predetermined concentration of oxygen,
wherein the system is configured to operate with a ratio of the tank absolute pressure to the absolute pressure entering the first orifice less than about 0.54 and at or below 0.5285 for a substantial portion of the tank pressure range, and
wherein the system is configured to operate with a ratio of the tank absolute pressure to the absolute pressure entering the second orifice less than about 0.54 and at or below 0.5285 for a substantial portion of the tank pressure range.

22. The system of claim 21, wherein the system is configured to operate with the ratio of the tank absolute pressure to the absolute pressure entering the first orifice between about 0.45 and 0.54 and wherein the system is configured to operate with the ratio of the tank absolute pressure to the absolute pressure entering the second orifice between about 0.45 and 0.54.

23. The system of claim 21, wherein the predetermined tank pressure range has an upper pressure limit and a lower pressure limit, wherein the difference between the upper pressure limit and the lower pressure limit is 1-20 psi.

24. The system of claim 23, wherein the difference between the upper pressure limit and the lower pressure limit is 5-15 psi.

25. The system of claim 24, wherein the difference between the upper pressure limit and the lower pressure limit is 12 psi.

26. The system of claim 25, wherein the predetermined tank pressure range is operable between about 70-82 psig.

27. The system of claim 26, wherein the oxygen pressure from the first pressure regulator means is operable between about 165-175 psig.

28. The system of claim 27, wherein the oxygen pressure from the first pressure regulator means is operable at about 171.5 psig.

29. The system of claim 26, wherein the nitrogen pressure from the second pressure regulator means is operable at between about 165-175 psig.

30. The system of claim 29, wherein the nitrogen pressure from the second pressure regulator means is operable at about 171.5 psig.

31. The system of claim 26, wherein the oxygen and nitrogen pressures from the first and second pressure regulator means respectively are operable at about 165-175 psig.

32. The system of claim 31, wherein the oxygen and nitrogen pressures from the first and second pressure regulator means respectively are operable at about 171.5 psig.

33. The system of claim 24, wherein the oxygen and nitrogen pressures from the first and second pressure regulator means respectively are operable at about 165-175 psig.

34. The system of claim 24, wherein the synthetic air contains not less than 19.5% and not more than 23.5%, by volume of O₂.

35. The system of claim 24, wherein the mixing component is configured to allow flow of the oxygen and the nitrogen from independent supply lines to converge to a single line leading to the tank.

36. The system of claim 24, wherein the first and the second critical flow orifices are incorporated into the mixing component.

37. The system of claim 24, wherein the mixing component is configured for side injection.

38. The system of claim 24, wherein the mixing component is configured for tangential mixing.

39. The system of claim 24, wherein the mixing component is configured for opposed flow mixing.

40. The system of claim 24, wherein the mixing component is configured for concentric mixing.

41. A method for producing synthetic air, comprising:
providing oxygen to a mixing component under first substantial critical flow conditions;
providing nitrogen to a mixing component under second substantial critical flow conditions; and
mixing the oxygen and nitrogen to provide synthetic medical air.

42. The system of claim 41, wherein the synthetic air contains not less than 19.5% and not more than 23.5%, by volume of O₂.

43. A method for producing synthetic air, comprising:
providing a source of oxygen to a first orifice having a predetermined size and configured to receive the oxygen within a predetermined pressure range;
providing a source of nitrogen to a second orifice having a predetermined size and configured to receive the nitrogen within a predetermined pressure range;
mixing the oxygen and the nitrogen to provide synthetic air having a predetermined concentration of oxygen;
providing a tank configured to operate within a tank pressure cycle having a predetermined tank pressure range to receive the synthetic air,
wherein the ratio of the tank absolute pressure to the absolute pressure entering the first orifice is less than about 0.54 and at or below 0.5285 for a substantial portion of the tank pressure range, and
wherein the ratio of the tank absolute pressure to the absolute pressure entering the second orifice is less than about 0.54 and at or below 0.5285 for a substantial portion of the tank pressure range.

44. The system of claim 43, wherein ratio of the tank absolute pressure to the absolute pressure entering the first orifice is between about 0.45 and 0.54 and wherein the ratio of the tank absolute pressure to the absolute pressure entering the second orifice is between about 0.45 and 0.54.

45. The system of claim 43, wherein the predetermined tank pressure range has an upper pressure limit and a lower pressure limit, wherein the difference between the upper pressure limit and the lower pressure limit is 1-20 psi.

46. The system of claim 45, wherein the difference between the upper pressure limit and the lower pressure limit is 5-15 psi.

47. The system of claim 46, wherein the difference between the upper pressure limit and the lower pressure limit is 12 psi.

48. The system of claim 47, wherein the predetermined tank pressure range is between about 70-82 psig.

49. The system of claim 43, wherein the synthetic air contains not less than 19.5% and not more than 23.5% by volume of O₂.

50. The system of claim 43, wherein the mixing of the oxygen and the nitrogen is from independent supply lines to converge to a single line leading to the tank.

51. The system of claim 43, wherein the first and the second orifices are incorporated into a mixing component.

52. A system for the production of synthetic air, comprising:
a source of oxygen at a predetermined oxygen pressure;
at least one oxygen orifice having a predetermined size and configured to receive oxygen at the predetermined oxygen pressure;
a source of nitrogen at a predetermined pressure;
at least one nitrogen orifice having a predetermined size and configured to receive nitrogen at the predetermined nitrogen pressure;
a mixing component configured to receive the oxygen and nitrogen;
a tank configured to operate within a tank pressure cycle having a predetermined tank pressure range and to receive the oxygen and the nitrogen to provide synthetic air having a predetermined concentration of oxygen,
wherein the system is configured to operate with a ratio of the tank absolute pressure to the absolute pressure entering the at least one oxygen orifice less than about 0.54 and at or below 0.5285 for a substantial portion of the tank pressure range, and
wherein the system is configured to operate with a ratio of the tank absolute pressure to the absolute pressure entering the at least one nitrogen orifice less than about 0.54 and at or below 0.5285 for a substantial portion of the tank pressure range.

53. A system for the production of synthetic air, comprising:
a source of oxygen;
a first pressure regulator connected to the oxygen source;
a first pressure gauge configured to indicate the pressure from the first pressure regulator;
at least one oxygen orifice having a predetermined size and configured to receive oxygen at a pressure of about the pressure indicated from the first pressure gauge;
a source of nitrogen;
a second pressure regulator connected to the nitrogen source;
a second pressure gauge configured to indicate the pressure from the second pressure regulator;
at least one nitrogen orifice having a predetermined size and configured to receive nitrogen at a pressure of about the pressure indicated from the second pressure gauge;
a mixing component configured to receive the oxygen and nitrogen;
a tank configured to operate within a tank pressure cycle having a predetermined tank pressure range and to receive the oxygen and the nitrogen to provide synthetic air having a predetermined concentration of oxygen,
wherein the system is configured to operate with a ratio of the tank absolute pressure to the absolute pressure entering the at least one oxygen orifice less than about 0.54 and at or below 0.5285 for a substantial portion of the tank pressure range, and
wherein the system is configured to operate with a ratio of the tank absolute pressure to the absolute pressure entering the at least one nitrogen orifice less than about 0.54 and at or below 0.5285 for a substantial portion of the tank pressure range.

54. The system of claim 53, wherein the at least one oxygen orifice comprises a multitude of oxygen orifices.

55. The system of claim 53, wherein the at least one nitrogen orifice comprises a multitude of nitrogen orifices.

56. The system of claim 53, wherein the at least one oxygen orifice comprises a multitude of oxygen orifices and wherein the at least one nitrogen orifice comprises a multitude of nitrogen orifices.
